(19) United States
(12) Patent Application Publication
(10) Pub. No.: US 2023/0416955 A1
(43) Pub. Date: Dec. 28, 2023

(54) MULTIFUNCTIONAL MARLIN SPIKE

(71) Applicant: Hangzhou Guairen Culture Creative Co. LTD, Hangzhou (CN)

(72) Inventor: Xiu CAO, Anqing (CN)

(21) Appl. No.: 18/315,301

(22) Filed: May 10, 2023

(30) Foreign Application Priority Data
Jun. 28, 2022 (CN) 2022216290790

(51) Int. Cl. D04B 3/02; B25F 1/02

(52) U.S. Cl. CPC D04B 3/02; B25F 1/02

(57) ABSTRACT

A multifunctional marlin spike is provided. Under the condition of keeping the structure of hollow tube, the multifunctional marlin spike is added with a replaceable tapered knitting needle, and can still keep the firmness of internal structures under the condition of strong stress operation, and in addition, functions of the multifunctional marlin spike are convenient to be switched. The multifunctional marlin spike includes a threading-cone functional head, a connecting tube, and a threading head; the threading head is disposed at an upper end of the connecting tube, and the threading-cone functional head is disposed at a lower end of the connecting tube; the connecting tube is a hollow tube structure, a tapered knitting needle is inserted in a connecting tube cavity of the connecting tube, and the tapered knitting needle includes a threaded head, a threading needle body, and a tapered needle.

### TECHNICAL FIELD

The disclosure relates to the outdoor survival tools, in particular to a multifunctional marlin spike.

### BACKGROUND

Marlin spike is a tool used for outdoor activities and fishing activities. In the prior art, the marlin spike is a metal conical structure with functional heads at both ends and a hollow tube at the middle connected to the both ends. After combining relevant functional heads with the hollow tube, the user can perform tasks such as splicing climbing ropes, making or untying knots, threading holes and rings, or tightening ropes during climbing. The marlin spike can also be used as a vertical measuring tool in camping and as a tool for fixing and threading tent ropes instead of tent pegs. After storing and assembling knitting needles, the marlin spike can be used as an auxiliary tool for weaving survival umbrella ropes, as well as for sewing and sealing bags, pockets, and so on. However, the functions of marlin spikes in the prior art are limited by their own hollow tube structures which often result in the hollow tubes being flattened and cracked, which seriously affects the scope of use of the stress operation of the marlin spikes. If the hollow tube is replaced by a solid tube, the structure is strengthened, but the marlin spike is not possible to store needle structures.

### SUMMARY

In order to solve the above problems, the disclosure provides a multifunctional marlin spike. Under the condition of keeping the structure of hollow tube, the multifunctional marlin spike is added with a replaceable tapered knitting needle, and can still keep the firmness of internal structures under the condition of strong stress operation, and in addition, functions of the multifunctional marlin spike are convenient to be switched.

The disclosure is achieved by following technical solutions: a marlin spike, including a threading-cone functional head, a connecting tube, and a threading head; the threading head is disposed at an upper end of the connecting tube, and the threading-cone functional head is disposed at a lower end of the connecting tube; the connecting tube is a hollow tube structure, a tapered knitting needle is configured to be inserted in a connecting tube cavity of the connecting tube, and the tapered knitting needle includes a threaded head, a threading needle body connected to the threaded head, and a tapered needle connected to the threading needle body;
the tapered knitting needle is configured to be inserted into the connecting tube from the tapered needle to the threaded head, screw threads provided on a bottom part of the threaded head are threaded with screw threads provided on an inner wall of the connecting tube, a top part of the connecting tube is provided with a top threaded tube, and the threading head is threaded with the top threaded tube and connected to the connecting tube; and
a top part of the threading-cone functional head is provided with a threaded neck tube, the threaded neck tube is connected to the threaded head of the tapered knitting needle, and thus the threading-cone functional head is indirectly connected to the connecting tube; or the threaded neck tube is threaded with the top part of the connecting tube, thereby to achieve a connection of the threading-cone functional head, the connecting tube, and the tapered knitting needle.

In an embodiment, the threading head includes a thimble ring head and a needle threader provided on a top part of the thimble ring head, and the needle threader is one of spherical, polyhedral and conical structures; and the needle threader is provided with a threading hole for threading. The thimble ring head is used as a thimble, and a line can be twined between the thimble ring head and the needle threader. The needle threader is used for pulling the line.

In an embodiment, the connecting tube is provided with a pull-line section, the pull-line section includes a tail ring and a pull-line tube body, a diameter of the tail ring is larger than a diameter of the pull-line tube body, one of concave ring grooves is provided between the tail ring and the pull-line tube body, and a tube body of the pull-line tube body is provided with a helical groove. The helical groove is used for twining a line to help the user pull the line and avoid direct manual pulling of the line, achieving the pulling of smooth lines such as metal wires, fish wires, etc., or other lines that can cut hands. The helical groove at an end of the pull-line tube body can also be tied with the line to avoid sliding.

In an embodiment, the connecting tube is provided with a bottle-shaped tube, a concave-convex structure of the bottle-shaped tube is configured to help a user grasp the marlin spike to avoid sliding; when two lines are tied to concave-groove structures at two ends of the bottle-shaped tube, the user uses two ends of the marlin spike for horizontal pulling and twining the two lines for horsetail or spiral knitting.

In an embodiment, the threading-cone functional head is a conical structure, the tapered knitting needle is a needle-shaped structure, a needle part of the tapered needle is provided with chamfered flat grooves, so that the needle part of the tapered needle forms a flat-head screwdriver structure. The flat-head screwdriver structure is used as a screwdriver or temporary cutting tool.

In an embodiment, each of the chamfered flat grooves is provided with a sanding layer. The sanding layer can be configured for sanding or breaking.

In an embodiment, the top part of the connecting tube is capable of being connected with a whistle tube. The whistling tube can be used as a warning sounding tool in the wild.

In an embodiment, the connecting tube cavity of the connecting tube is capable of being inserted with a ferro rod. The ferro rod can cooperate with the sanding layer of the threading head to perform sparking when a fire is needed.

In an embodiment, a concave ring groove is provided between the tail ring and the pull-line tube body, another concave ring groove is provided between the pull-line tube body and a bottle-shaped tube. The concave ring grooves can fix two segments of lines to perform horizontal pulling.

The disclosure has following beneficial effects: 1. the structure is simpler, the multidirectional storage is realized, the tapered knitting needle stored under a storage condition can fill the space in the whole tube cavity of the connecting tube, and the firmness of the whole connecting tube is greatly improved after the space in the tube cavity is filled; 2. the marlin spike provided by disclosure can help pull various lines to prevent a hand from being cut and hurt; 3. the marlin spike provided by disclosure can tie wires horizontally for making helical lines and horsetail lines; 4. the overall structure is modular, which makes the marlin spike be cheap to manufacture, easy to transform, and easy to promote; 5. the connecting tube can be combined with other structures to form a multifunctional rod, and functional structures such as a whistle tube, a ferro rod, a grinding rod, etc. can be set on the multifunctional rod. In addition to the knitting function, the marlin spike of disclosure can also provide the functions of making sound, making fire, grinding, and emergency cutting in the wild.

### BRIEF DESCRIPTION OF DRAWINGS

In order to more clearly illustrate the technical solution of the embodiments of the disclosure, the following will briefly introduce attached drawings needed in the embodiments. It should be understood that the following attached drawings only illustrate some embodiments of the disclosure, and therefore should not be considered as a limit of the disclosure. For those skilled in the art, other relevant drawings obtained from these drawings without creative work should belong to the scope of protection of the disclosure.

FIG. 1 illustrates a structural diagram of a marlin spike in the prior art.

FIG. 2 illustrates a schematic diagram of internal and external structures of a marlin spike of the disclosure.

FIG. 3 illustrates another schematic diagram of the internal and external structures of the marlin spike of the disclosure.

FIG. 4 illustrates a combined diagram of functional structures of the disclosure.

FIG. 5 illustrates a schematic diagram of internal and external structures of the marlin spike of the disclosure when a connecting tube is connected to a tapered knitting needle.

FIG. 6 illustrates a structural diagram of the marlin spike as a double-headed needle in an embodiment of the disclosure.

FIG. 7 illustrates a structural diagram of the marlin spike as a double-headed needle in another embodiment of the disclosure.

### DESCRIPTION OF REFERENCE NUMERALS

1—threading-cone functional head; 2—connecting tube; 3—threading head; 4—connecting tube cavity; 5—tapered knitting needle; 6—threaded head; 7—threading needle body; 8—tapered needle; 9—top threaded tube; 10—threaded neck tube; 11—thimble ring head; 12—needle threader; 13—threading hole; 14—pull-line section; 15—tail ring; 16—pull-line tube body; 17—helical groove; 18—bottle-shaped tube; 19—chamfered flat groove; 20—sanding layer; 21—whistle tube; 22—ferro rod; 23—concave ring groove.

### DETAILED DESCRIPTION OF EMBODIMENTS

Embodiments of the disclosure are described in detail below, and exemplary embodiments are shown in attached drawings. In the description of the disclosure, it is necessary to understand that the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential”, and so on that indicate orientation or positional relationship are based on the orientation or positional relationship shown in the attached drawings. These terms are only intended to facilitate the description and simplification of the disclosure, and these terms are not intended to indicate or imply that the device or element referred to must be constructed and operated in a specific orientation, and therefore these terms cannot be understood as a limitation of the disclosure.

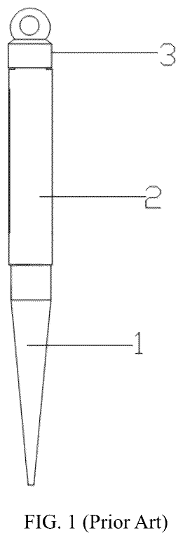

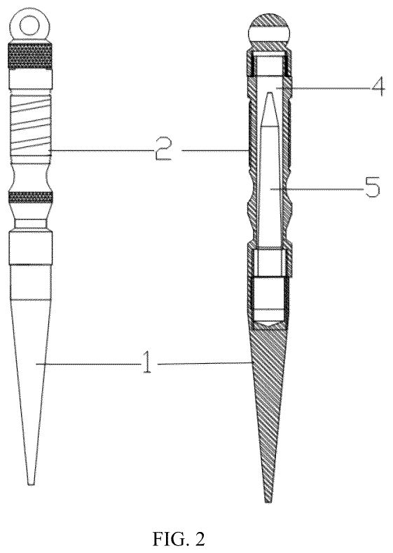

The disclosure is achieved by following contents: in an embodiment, a marlin spike in the prior art as shown in FIG. 1, the marlin spike includes a threading-cone functional head 1, a connecting tube 2, and a threading head 3. The threading head 3 is disposed at an upper end of the connecting tube 2, and the threading-cone functional head 1 is disposed at a lower end of the connecting tube 2. Compared with the marlin spike in the prior art, a multifunctional marlin spike have more functions as shown in FIG. 2, a connecting tube 2 is a hollow tube structure, a tapered knitting needle 5 configured to be inserted in a connecting tube cavity 4 of the connecting tube 2, and the tapered knitting needle 5 includes a threaded head 6 provided at an end of the tapered knitting needle 5, a threading needle body 7 connected to the threaded head 6, and a tapered needle 8 connected to the threading needle body 7. The structure of the marlin spike of the disclosure is simpler, and the multidirectional storage is realized.

As shown in FIG. 2, the tapered knitting needle 5 is configured to be inserted into the connecting tube 2 from the tapered needle 8 to the threaded head 6, screw threads provided on a bottom part of the threaded head 6 are threaded with screw threads provided on an inner wall of the connecting tube 2, a top part of the connecting tube 2 is provided with a top threaded tube 9, and the threading head 3 is threaded with the top threaded tube 9 and connected to the connecting tube 2. When we only need to use the traditional function of the threading-cone functional head 1, we can store the tapered knitting needle 5 in the connecting tube 2.

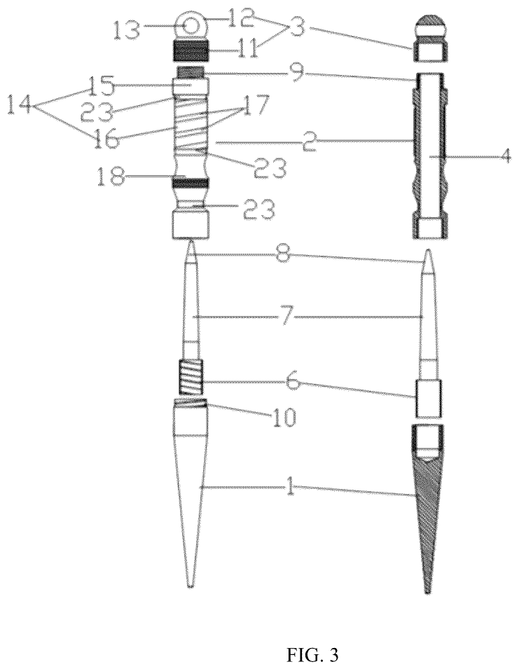

As shown in FIG. 3, a top part of the threading-cone functional head 1 is provided with a threaded neck tube 10. In an embodiment, as shown in FIG. 2, the threaded neck tube 10 is connected to the threaded head 6 of the tapered knitting needle 5, and thus the threading-cone functional head 1 is indirectly connected to the connecting tube 2 into a whole. In an embodiment, as shown in FIG. 7, the threaded neck tube 10 is threaded with the top part of the connecting tube 2, thereby to achieve an integrated connection of the threading-cone functional head 1, the connecting tube 2, and the tapered knitting needle 5. Therefore, the disclosure provides two types of double-headed needles.

As shown in FIG. 3, the threading head 3 includes a thimble ring head 11 and a needle threader 12 provided on a top part of the thimble ring head 11, and the needle threader 12 is one of spherical, polyhedral and conical structures; and the needle threader 12 is provided with a threading hole 13 for threading. The thimble ring head 11 is used as a thimble, and a line can be twined between the thimble ring head 11 and the needle threader 12. The needle threader 12 is used for pulling the line. Lines and vines are threaded into the threading hole 13 of the needle threader 12 for knitting a mesh, or the threading hole 13 is used for threading a tent rope into the ground for fixing the tent.

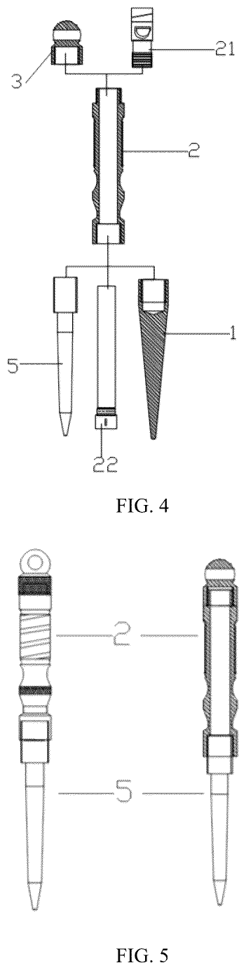

As shown in FIG. 2, FIG. 3, and FIG. 5, the connecting tube 2 is provided with a pull-line section 14, the pull-line section 14 includes a tail ring 15 and a pull-line tube body 16, a diameter of the tail ring 15 is larger than a diameter of the pull-line tube body 16, and a tube body of the pull-line tube body 16 is provided with a helical groove 17. The helical groove 17 is configured for twining a line to help the user pull the line and avoid direct manual pulling of the line, achieving the pulling of smooth lines such as metal wires, fish wires, etc., or other lines that can cut hands. The helical groove 17 at a lower part of the pull-line tube body can also be tied with the line to avoid sliding. After filling the space inside the connecting tube 2 with the tapered knitting needle 5, the firmness of the whole connecting tube 2 has been greatly improved, and the connecting tube 2 does not deform during the pulling.

As shown in FIG. 3, the connecting tube 2 is provided with a bottle-shaped tube 18, a concave-convex structure of the bottle-shaped tube 18 is configured to help a user grasp the marlin spike to avoid sliding; when two lines are tied to concave-groove structures at two ends of the bottle-shaped tube 18, the user uses two ends of the marlin spike for horizontal pulling and twining the two lines for horsetail or spiral knitting.

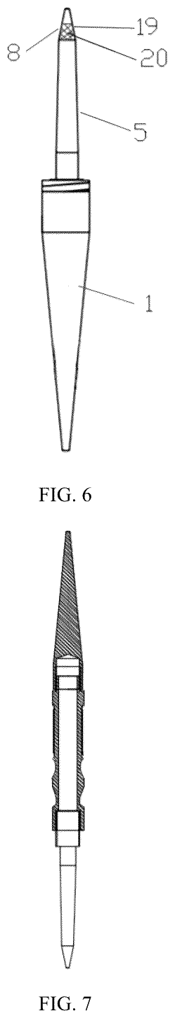

As shown in FIG. 6, the threading-cone functional head 1 is a conical structure, the tapered knitting needle 5 is a needle-shaped structure, a needle part of the tapered needle 8 is provided with chamfered flat grooves 19, so that the needle part of the tapered needle 8 forms a flat-head screwdriver structure. The flat-head screwdriver structure is used as a screwdriver or temporary cutting tool. Each of the chamfered flat grooves 19 is provided with a sanding layer 20. The sanding layer 20 can be configured for sanding or breaking.

As shown in FIG. 4, the top part of the connecting tube 2 is capable of being connected with a whistle tube 21. The whistling tube 21 can be used as a warning sounding tool in the wild. The connecting tube cavity 4 of the connecting tube 2 is capable of being inserted with a ferro rod 22. The ferro rod 22 can cooperate with the sanding layer 20 of the tapered needle 8 to perform sparking when a fire is needed.

As shown in FIG. 3 and FIG. 5, a concave ring groove 23 is provided between the tail ring 15 and the pull-line tube body 16, another concave ring groove 23 is provided between the pull-line tube body 16 and a bottle-shaped tube 18. The concave ring grooves 23 can fix multiple segments of lines to perform horizontal pulling on the lines.

The above are only some embodiments of the disclosure, and cannot limit the scope of the claims of the disclosure. For those skilled in the art, any other corresponding changes made using the technical solutions and concept of the disclosure should fall within the scope of protection of the claims of the disclosure.

What is claimed is:

1. A marlin spike, comprising a threading-cone functional head (1), a connecting tube (2), and a threading head (3); wherein the threading head (3) is disposed at an upper end of the connecting tube (2), and the threading-cone functional head (1) is disposed at a lower end of the connecting tube (2); the connecting tube (2) is a hollow tube structure, a tapered knitting needle (5) is configured to be inserted in a connecting tube cavity (4) of the connecting tube (2), and the tapered knitting needle (5) comprises a threaded head (6), a threading needle body (7) connected to the threaded head (6), and a tapered needle (8) connected to the threading needle body (7);
wherein the tapered knitting needle (5) is configured to be inserted into the connecting tube (2) from the tapered needle (8) to the threaded head (6), screw threads provided on a bottom part of the threaded head (6) are threaded with screw threads provided on an inner wall of the connecting tube (2), a top part of the connecting tube (2) is provided with a top threaded tube (9), and the threading head (3) is threaded with the top threaded tube (9) and connected to the connecting tube (2); and
wherein a top part of the threading-cone functional head (1) is provided with a threaded neck tube (10), the threaded neck tube (10) is connected to the threaded head (6) of the tapered knitting needle (5), and thus the threading-cone functional head (1) is indirectly connected to the connecting tube (2); or the threaded neck tube (10) is threaded with the top part of the connecting tube (2), thereby to achieve a connection of the threading-cone functional head (1), the connecting tube (2) and the tapered knitting needle (5).

2. The marlin spike according to claim 1, wherein the threading head (3) comprises a thimble ring head (11) and a needle threader (12) provided on a top part of the thimble ring head (11), and the needle threader (12) is one of spherical, polyhedral and conical structures; and the needle threader (12) is provided with a threading hole (13) for threading.

3. The marlin spike according to claim 1, wherein the connecting tube (2) is provided with a pull-line section (14), the pull-line section (14) comprises a tail ring (15) and a pull-line tube body (16), a diameter of the tail ring (15) is larger than a diameter of the pull-line tube body (16), a concave ring groove (23) is provided between the tail ring (15) and the pull-line tube body (16), and a tube body of the pull-line tube body (16) is provided with a helical groove (17).

4. The marlin spike according to claim 1, wherein the connecting tube (2) is provided with a bottle-shaped tube (18), a concave-convex structure of the bottle-shaped tube (18) is configured to help a user grasp the marlin spike to avoid sliding; when two lines are tied to concave-groove structures at two ends of the bottle-shaped tube (18), the user uses two ends of the marlin spike for horizontal pulling and twining the two lines for horsetail or spiral knitting.

5. The marlin spike according to claim 1, wherein the tapered knitting needle (5) is a conical structure, the tapered needle (8) is a needle-shaped structure, a needle part of the tapered needle (8) is provided with chamfered flat grooves (19), so that the needle part of the tapered needle (8) forms a flat-head screwdriver structure.

6. The marlin spike according to claim 5, wherein each of the chamfered flat grooves (19) is provided with a sanding layer (20).

7. The marlin spike according to claim 1, wherein the top part of the connecting tube (2) is capable of being connected with a whistle tube (21).

8. The marlin spike according to claim 1, wherein the connecting tube cavity (4) of the connecting tube (2) is capable of being inserted with a ferro rod (22).

9. The marlin spike according to claim 3, wherein another concave ring groove (23) is provided between the pull-line tube body (16) and a bottle-shaped tube (18).
